(19) United States
(12) Patent Application Publication
(10) Pub. No.: US 2010/0102781 A1
(43) Pub. Date: Apr. 29, 2010

(54) APPARATUS AND METHOD FOR CHARGING A BATTERY

(75) Inventors: Jan-Olof SVENSSON, KIVIK (SE); Mats Wolf, Sodra Sandby (SE); Nacki Sachpekidis, Lund (SE); Tomas Mellblom, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/257,662

(22) Filed: Oct. 24, 2008

(51) Int. Cl. H02J 7/00

(52) U.S. Cl. 320/157

(57) ABSTRACT

The present invention relates to an apparatus and method for charging a battery cell according to a charging scheme. The apparatus comprises a power supply and control unit for delivering a charging current to the battery cell according to said scheme, a current monitoring device for monitoring and measuring the charging current, a voltage monitoring device for monitoring and measuring the voltage over the battery cell, a charging terminator devised for terminating the charging of the battery when a predetermined charging criteria is met and a safety timer for starting a predetermined time interval when charging of the battery cell has reached its constant voltage. The predetermined charging criteria is met either when the charging current is falling below a predetermined limit or when the charging current has not decreased a predetermined amount, ΔI, within the predetermined time interval.

### TECHNICAL FIELD OF THE INVENTION

The present invention relates to an apparatus and a method for charging battery cells. Typically, the present invention may be used for charging lithium ion or lithium polymer battery cells, which are suitable to be used as a power supply in portable electronic devices.

### DESCRIPTION OF RELATED ART

Lithium-based battery cells have almost become standard today when it comes to use of secondary battery cells in portable electronic devices. Such batteries demonstrate higher performance than e.g. the nickel metal-hydride batteries, i.e. have a higher energy density, and therefore increase the battery usable or operable time. Examples of electronic devices were lithium-based battery cells can be found is mobile phones, laptop computers and personal digital assistants PDAs. An example of such a lithium-based battery cell is a lithium-ion cell. Another lithium-based battery type having an even higher energy density is the lithium-polymer cell.

However, there are also some drawbacks when using lithium-based battery cells. One problem is that they are very sensitive when it comes to overcharging. If you overcharge a lead acid battery it will electrolyze simply by replacing some water, and a sealed nickel-cadmium or metal-hydride battery will stop the voltage from rising when it is fully charged. However, the voltage of the lithium ion and lithium polymer battery cell continues to rise when it is overcharged. The voltage of a lithium ion battery cell rises quite distinctly at the end of charging cycle. Overcharging will therefore seriously damage the lithium-based cells and consequently overcharging must be avoided. Overcharging can be seen as a depletion of the lithium ions at the positive electrode. When overcharging occurs performance degradation will take place.

In order to avoid overcharging of lithium-based cells it is common to use a two-step charging process. This process is known as the Constant Current Constant Voltage method (CCCV). Usually, the constant voltage CV of a lithium cell is 4.2 V. With the CCCV method, the battery cell is first charged with a constant current until the voltage in the cell reaches 4.2 V. Once this level has been reached a charging control system keeps the voltage constant at 4.2 V at which level the battery cell continues to be charged. This charging will continue until the charging current has dropped below a predetermined current value, i.e. the cut-off value. Once the predetermined current level has been detected the battery cell is assumed to be fully charged.

However, lithium-based battery cells are not only sensitive to overcharging, they are also sensitive to be exposed to high voltage for an extensive period of time. With other words the longer the battery is exposed to high voltage the more it will deteriorate and negatively affect the durability. One attempt to overcome this problem has been to simply lower the CV to e.g. 4.1 V. On the other hand, with such a solution the capacity of the battery cell will inevitably decrease, due to the lower charging voltage.

A problem with the charging according to the CCCV method is that the current decreases exponentially during the CV phase, in which the current decreases at a slower rate, as it gets closer to the predetermined cut-off value. Thus, the battery cell will be held at the high voltage during a prolonged time, during which damage may be caused to the cell.

The time may be further prolonged if there arises internal shorts in the battery cell. The internal shorts may arise due to deficiencies in the material or the manufacturing process. Furthermore, internal shorts may arise due to aging or external abuse such as dropping the battery cell. Internal shorts are a potential safety hazard and may in a worst case scenario lead to thermal runaway, either instantly or delayed when loaded or abused in a later situation. This is of course a situation that one will avoid at any cost.

When internal shorts arise the charging current will not decrease at the same rate as it would normally due. Thus, the battery cell may be subjected to the high voltage during a considerable time.

It is also known to use timers, which on time out will terminate the charging of the battery. This has been the simplest and most wide spread charging process prior to the CCCV method and is still used in many applications today. However, there is a problem with this method, since the time set in the timer must be set long enough to secure that the battery cell is charged, with the drawback of possible exposing the battery cell to excessive high voltage. However, the timer might also be set for a shorter period of time to prevent overcharging. However, this will often lead to that the battery cell is not fully charged, which in the long run also will deteriorate the battery cell.

In EP 1455194 there is described a apparatus and method for charging a battery cell in which the amount of charge received by the battery cell is calculated by integrating the measured charging current over the charging time. The monitoring of the charge level has two purposes; firstly it is used to terminate the charging when a predetermined charge value has been reached, and secondly it is used for displaying the charge level of the battery cell during use, such that a user may view the charge level. This solution is somewhat complex since it is not only directed to charging.

Consequently, there is still a need for improvements in when it comes to charging battery cells that are sensitive to high voltage, especially lithium ion and lithium polymer battery cells.

### SUMMARY OF THE INVENTION

Hence, it is an object of the present invention to overcome the above-identified deficiencies related to the prior art.

According to a first aspect of the present invention this object is fulfilled by an apparatus for charging a battery cell according to a charging scheme, comprising a power supply and control unit for delivering a charging current to the battery cell according to said scheme, a current monitoring device for monitoring and measuring the charging current, a voltage monitoring device for monitoring and measuring the voltage over the battery cell, a charging terminator devised for terminating the charging of the battery when a predetermined charging criteria is met and a safety timer for timing the charging of the battery cell starting from a safety timer starting point, in which the control unit is arranged and configured in such a way that the predetermined charging criteria is met either when the charging current is falling below a predetermined limit or when a predetermined time has elapsed from the safety timer starting point.

According to one embodiment of the invention the control unit is configured to execute a modified CCCV charging scheme and the safety timer starting point corresponds to the starting point of the constant voltage phase. Preferably, the predetermined time for timing out the safety timer is set to one hour.

In another preferred embodiment the control unit also is configured to execute a modified CCCV charging scheme, but the safety timer starting point corresponds to the starting point of the battery charging process. Preferably, the predetermined time for timing out the safety timer is set to two hours.

According to another aspect of the invention the apparatus for charging a battery cell comprises a safety timer for starting a predetermined time interval when charging of the battery cell has reached its constant voltage and the control unit is arranged and configured in such a way that the predetermined charging criteria is met either when the charging current is falling below a predetermined limit or when the charging current has not decreased a predetermined amount, ΔI, within the predetermined time interval.

Preferably, the predetermined time interval is set to 15 minutes and ΔI to 0.05 Ampere. In another embodiment it is preferred to set the time interval to 30 minutes and ΔI is 0.1 Ampere.

Preferably, the apparatus according to the present invention is adapted to the charging of lithium ion or lithium polymer battery cells.

According to a second aspect the stated object is fulfilled by a method for charging a battery cell according to a charging scheme, comprising the steps of:
supplying a constant charging current to said battery cell,
measuring the voltage over the battery cell,
terminating the constant current charging when the measured voltage reached a predetermined voltage value,
holding a constant voltage across said battery cell
terminating the charging process either when the charging current is falling below a predetermined limit or when a predetermined time has elapsed from a safety timer starting point.

In a preferred method the safety timer starting point corresponds to the starting point of the constant voltage phase.

In yet another preferred embodiment of the present invention the safety timer starting point corresponds to the starting point of the battery charging process.

Preferably, the predetermined time for timing out the safety timer is set to one hour.

Furthermore, the present invention relates to a method in which the termination of the charging process is made either when the charging current is falling below a predetermined limit or when the charging current has not decreased a predetermined amount, ΔI, within a predetermined time interval.

Preferably, the predetermined time interval is set to 15 minutes and ΔI is 0.05 Ampere. In another embodiment of the present invention the predetermined time interval is set to 30 minutes and ΔI is 0.1 Ampere.

The method furthermore is directed towards a battery cell that comprises a lithium ion or lithium polymer battery cell.

### BRIEF DESCRIPTION OF THE DRAWINGS

The present invention will now be described in more detail in relation to the enclosed drawings, in which:

FIG. 1 schematically shows an exemplary embodiment of an apparatus according to the invention,

FIG. 2 illustrates a diagram of the charging process according to a CCCV method,

### DETAILED DESCRIPTION OF EMBODIMENTS

In the description of the present invention it will be referred to battery cells for use with electronic equipment, such as communication or data processing terminals. One type of communication terminal for which the invention is suitable is a portable radio communication terminal, such as a mobile phone. However, the invention is applicable to many types of electronic devices, particularly portable electronic devices, such as pagers, communicators, electronic organizers, smart phones, PDA:s (Personal Digital Assistants), laptop computers, and so on. Furthermore, it should be emphasized that the term comprising or comprises, when used in this description and in the appended claims is used to indicate included features, elements or steps, and is not to be interpreted as excluding the presence of other features, elements or steps than those expressly stated.

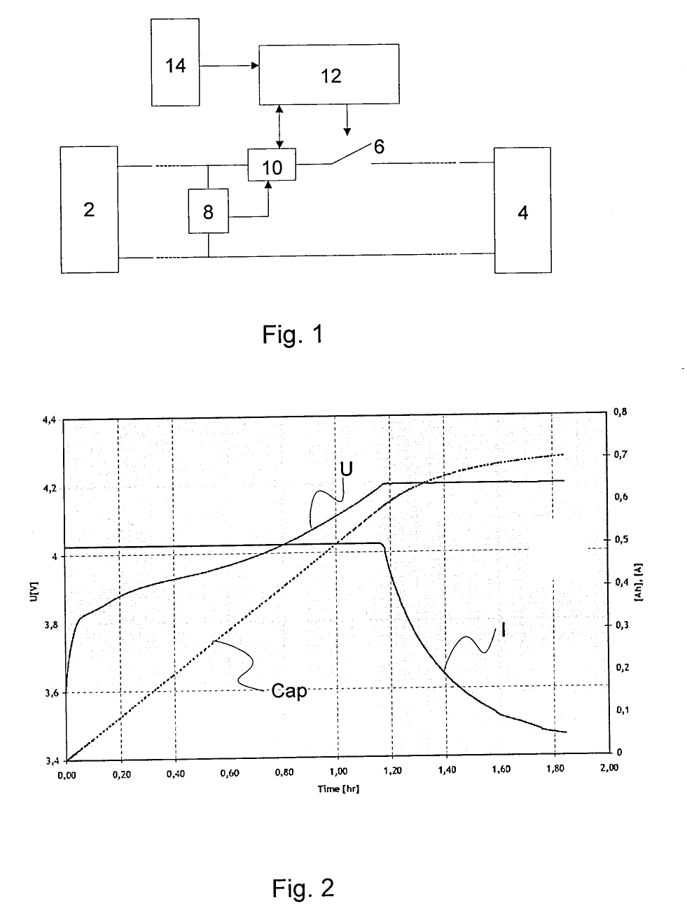

FIG. 1 illustrates an embodiment of the apparatus according to the present invention. It should be stressed that the elements of the drawing are illustrated as functional items with communicative interconnections, which means that they do not necessarily represent physical entities. Means for calculating and controlling a process or device may be realized in hardware, but may also in many cases be realized by a microprocessor system with associated software. The present invention may thus include both hardware and software.

The apparatus for controlling charging of a battery cell may be implemented in an electronic device, such as a mobile phone. Alternatively, the apparatus is contained in a casing carrying the battery. Another alternative is to implement the apparatus in a charger, which is connectable to a power supply, such as a mains outlet.

Returning now to FIG. 1, which illustrates a battery cell 2 having two poles. The battery cell 2 may be of a lithium ion or lithium polymer type. However the present invention is also applicable to other similar battery cells such as lithium manganese or any other type of battery cell that is sensitive to overcharging. As is indicated by the dashed lines the battery cell 2 is connectable to an apparatus for charging the battery cell 2. FIG. 1 also depicts a power supply 4, which may be a battery cell charger connectable to an electronic device carrying the apparatus and the battery cell 2. The power supply 4 supplies electric energy to the apparatus for charging the battery cell 2.

Furthermore, there is provided a charging terminator 6 for cutting of the charging process when predetermined charging criteria is met. In a preferred embodiment of the present invention the charging terminator 6 has the form of a simple switch. When the switch is in its open state it will interrupt the connection between the battery cell 2 and the power supply 4 and thereby cot off the charging process.

The apparatus further comprises a voltage-monitoring device 8 for sensing the voltage across the two poles of the battery cell 2. Also a current-monitoring device 10 is connected to at least one of the battery poles for measuring the charging current supplied to the battery cell 2. The apparatus also comprises a control unit 12, which is used to control the charging process and collect data from the voltage 8 and current 10 monitoring devices. The control unit 12 might be realized as a microcomputer and suitable software or in any other suitable way. It is obvious to a person skilled in the art how to design a control unit 12 given the present description and it is therefore not described in detail. The control unit 12 is also connected to a safety timer 14, which is used in order to determine if one of the predetermined criteria has been met, which will be described closer below.

Thus, the different parts of the apparatus for charging a battery cell 2 have been described. As mentioned above, each individual part is not necessarily a separate physical unit, but is described as such in order to better explain the present invention.

When charging the battery cell 2, a modified CCCV process is used. FIG. 2 illustrates a diagram of the charging process according to the CCCV method, showing curves for the current I, the voltage U and the charge capacity Cap. These curves represent an ideal case, i.e. a battery in perfect condition and which not has been subjected to for instance internal shorts. In this case the CCCV method will charge the battery without deteriorating it. However, this is seldom the case. Usually, the CCCV method starts with supplying a constant current of in this case 0.5 Ampere until the battery voltage reaches 4.2 Volts. Thereafter the voltage is kept constant at 4.2 Volts until the current falls below a predetermined limit of 0.05 Ampere. At this point the charging process will be interrupted.

The method according to the present invention starts in the same manner as the CCCV when the battery cell 4 is to be charged. In order to start the process the battery cell 2 is connected to the apparatus for charging a battery, which in turn is connected to the power supply 4. A first charging phase is performed with a constant current, which is controlled by said control unit 12. Upon supply of said constant current the voltage monitoring device 8 senses the voltage over the battery cell 2, which voltage will rise as the charging proceeds.

When the voltage, as mentioned above, has reached a predetermined charging voltage level value, which for the example of a lithium polymer or Li-Ion battery cell may be 4.2 V, this voltage is sensed by voltage monitoring device 8 and reported to the control unit 12, as is indicated by the arrow connecting the two elements in FIG. 1. Once the charging voltage level value has been reached, the charging proceeds according to a constant voltage procedure. As the battery cell 2 is charged at the charging voltage level value, the charging current of the battery cell 2 will continuously decrease. In this phase of the charging, predetermined charging criteria may be used for determining when the charging should be terminated, since it is not desirable to apply a high voltage to the battery cell longer than necessary, due to the degradation this might cause.

According to the invention, the current-controlled constant voltage part of the charging is targeted for setting charging criteria to be met for terminating the charging process. According to one preferred embodiment of the present invention the charging criteria is either when the charging current is falling below a predetermined limit, for example 0.05 Ampere for a 4.2 Volts lithium ion battery, or when a predetermined time has elapsed from the safety timer starting point. The first criterion is useful as long as the battery cell 2 behaves as it is supposed to do, i.e. the current will drop below the predetermined limit within a reasonable time. On the other hand if this is not the case the great benefit of the invention really comes to use.

This second criterion uses the safety timer 14, which may be started at some point during the charging process. Preferably the safety timer 14 is started when the charging process enters the constant voltage phase. However it is also possible to start the safety timer 14 when the first constant current charging phase starts. The import thing is that the time counting from the safety timer 14 starting point until the terminating point for an ideal charging process is known. These known facts are programmed into the control unit 12 and used to control the charging process and terminate it when the safety timer 14 has reached a predetermined time. This predetermined time is usually somewhat longer than the time for an ideal charging process.

In another preferred embodiment of the invention the second charging criterion is not only a predetermined time but instead a measurement of ΔI, i.e. the change in charging current over a predetermined period of time. This measurement takes place during the second constant voltage phase of the charging process. The predetermined period of time is set by the safety timer 14. This time period may vary depending on the type of battery that is charged, but also depending on how long the charging process has been going on. The reason for this is that it might be preferable to adapt the time to the exponential current charging curve. For example, at the beginning of the constant voltage phase the current decreases fast and a short period of time may be used to detect a current change, ΔI, of 0.05 Ampere. However, at the end of the charging process it might take much longer time to detect the same current change. All these time periods and current changes may be programmed into the control unit 12. How this is done is considered to be within the capabilities of a skilled person and is therefore not described any further.

In other words, the charging proceeds until it is determined that a predetermined charging criterion has been met. The whole charging process is controlled by the control unit 12, which collects input voltage and current values from the voltage 8 and current 10 monitoring devices.

It should be understood that the foregoing has described principles, preferred embodiments and modes of operation of present invention. However, the invention should not be limited to particular embodiment discussed above, which should be regarded as illustrative rather then restrictive. Thus, even if for example batteries having 4.2 Volts have been described it is obvious that the apparatus and method for charging a battery is applicable to batteries having all kind of voltages. The same goes for different current levels, which easy could be adapted to the type of battery used. Thus, the present invention is best defined by the following claims.

1. Apparatus for charging a battery cell according to a charging scheme, comprising a power supply and control unit for delivering a charging current to the battery cell according to said scheme, a current monitoring device for monitoring and measuring the charging current, a voltage monitoring device for monitoring and measuring the voltage over the battery cell, a charging terminator devised for terminating the charging of the battery when a predetermined charging criteria is met and a safety timer for timing the charging of the battery cell starting from a safety timer starting point, in which the control unit is arranged and configured in such a way that the predetermined charging criteria is met either when the charging current is falling below a predetermined limit or when a predetermined time has elapsed from the safety timer starting point.

2. Apparatus for charging a battery cell according to claim 1, wherein the control unit is configured to execute a modified CCCV charging scheme and the safety timer starting point corresponds to the starting point of the constant voltage phase.

3. Apparatus for charging a battery cell according to claim 1, wherein the control unit is configured to execute a modified CCCV charging scheme and the safety timer starting point corresponds to the starting point of the battery charging process.

4. Apparatus for charging a battery cell according to claim 2, wherein the predetermined time for timing out the safety timer is set to one hour.

5. Apparatus for charging a battery cell according to claim 3, wherein the predetermined time for timing out the safety timer is set to two hours.

6. Apparatus for charging a battery cell according to a charging scheme, comprising a power supply and control unit for delivering a charging current to the battery cell according to said scheme, a current monitoring device for monitoring and measuring the charging current, a voltage monitoring device for monitoring and measuring the voltage over the battery cell, a charging terminator devised for terminating the charging of the battery when a predetermined charging criteria is met and a safety timer for starting a predetermined time interval when charging of the battery cell has reached its constant voltage, in which the control unit is arranged and configured in such a way that the predetermined charging criteria is met either when the charging current is falling below a predetermined limit or when the charging current has not decreased a predetermined amount, ΔI, within the predetermined time interval.

7. Apparatus for charging a battery cell according to claim 6, wherein the predetermined time interval is set to 15 minutes and ΔI is 0.05 Ampere.

8. Apparatus for charging a battery cell according to claim 6, wherein the predetermined time interval is set to 30 minutes and ΔI is 0.1 Ampere.

9. Apparatus according to claim 1, wherein the battery cell is a lithium ion or lithium polymer battery cell.

10. Apparatus according to claim 6, wherein the battery 10 cell is a lithium ion or lithium polymer battery cell.

11. Method for charging a battery cell according to a charging scheme, comprising the steps of:
supplying a constant charging current to said battery cell,
measuring the voltage over the battery cell,
terminating the constant current charging when the measured voltage reached a predetermined voltage value,
holding a constant voltage across said battery cell
terminating the charging process either when the charging current is falling below a predetermined limit or when a predetermined time has elapsed from a safety timer starting point.

12. Method according to claim 10, wherein the safety timer starting point corresponds to the starting point of the constant voltage phase.

13. Method according to claim 10, wherein the safety timer starting point corresponds to the starting point of the battery charging process.

14. Method according to claim 11, wherein the predetermined time for timing out the safety timer is set to one hour.

15. Method for charging a battery cell according to a charging scheme, comprising the steps of:
supplying a constant charging current to said battery cell,
measuring the voltage over the battery cell,
terminating the constant current charging when the measured voltage reached a predetermined voltage value,
holding a constant voltage across said battery cell
terminating the charging process either when the charging current is falling below a predetermined limit or when the charging current has not decreased a predetermined amount, ΔI, within a predetermined time interval.

16. Method according to claim 15, wherein the predetermined time interval is set to 15 minutes and ΔI is 0.05 Ampere.

17. Method according to claim 15, wherein the predetermined time interval is set to 30 minutes and ΔI is 0.1 Ampere.

18. Method according to claim 11, wherein the battery cell comprises a lithium ion or lithium polymer battery cell.

19. Method according to claim 15, wherein the battery cell comprises a lithium ion or lithium polymer battery cell.
